(19) United States
(12) Patent Application Publication
(10) Pub. No.: US 2005/0213453 A1
(43) Pub. Date: Sep. 29, 2005

(54) Disk playback apparatus and disk acceleratiion adjusting method

(75) Inventors: Masahiro Hojo, Osaka (JP); Norio Hatanaka, Yawata-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/082,654

(22) Filed: Mar. 18, 2005

(30) Foreign Application Priority Data
Mar. 26, 2004 (JP) P2004-092343

(51) Int. Cl. G11B 5/09

(52) U.S. Cl. 369/47.54; 369/47.38

(57) ABSTRACT

When servo lock cannot be achieved because the number of disk revolutions cannot reach the vicinity of its regular number of disk revolutions, a table value is increased to prolong the disk acceleration time. In case of success in servo lock, the table value is reduced to shorten the disk acceleration time. Accordingly, it is possible to set the disk acceleration time optimized in accordance with a variation of torque in the disk motor. As a result, it is possible to save an unnecessary current which would be otherwise consumed till disk servo lock is achieved, so that it is possible to suppress the power consumption.

This application is based on Japanese Patent Application No. 2004-092343, which is incorporated herein by reference.

### BACKGROUND OF THE INVENTION

1. Field of the Invention

The present invention relates to disk playback apparatus and a disk acceleration adjusting method suitable for use in electronic equipment for reproducing data recorded in various disks, such as a CD (Compact Disk) player, a DVD (Digital Versatile Disk) player, an MO (Magneto Optical disk) drive, etc.

2. Description of the Related Art

In the related art, the aforementioned disk playback apparatus adjusts disk acceleration before starting reading data recorded in a disk. In this adjustment of disk acceleration, it is necessary to lift up the number of revolutions to the vicinity of its regular one till the disk acceleration is terminated.

FIG. 8 is a flow chart showing a disk acceleration adjusting process of disk playback apparatus in the related art. First, a disk acceleration time T0 is set (S601). The disk acceleration time T0 in this event is a fixed value (e.g. one second), which will remain unchanged. After the disk acceleration time T0 is set, accelerating a disk motor is started (S602) . An elapsed time T since starting the disk acceleration is counted (S603), and it is determined whether one second has passed or not (S604) . When one second has not passed (No in S604), the process returns to S603. When one second has passed (Yes in S604), accelerating the disk motor is stopped (S605). After accelerating the disk motor is stopped, all servo controls are turned on (S606) . Next, it is determined whether all the servo controls are locked or not (S607) . When all the servo controls are not locked, the process returns to S601. When all the servo controls are locked, a disk read process is started (S608).

In such a manner, according to the related-art disk acceleration adjusting method, the disk acceleration time is set at a fixed value in advance, and accelerating the disk motor is stopped when the elapsed time T counted since the start of disk acceleration has reached the fixed value. Then, reading the disk is started when the servo controls are locked after accelerating the disk motor is stopped. The disk acceleration adjusting method of the disk playback apparatus in the related art is carried out as above.

As a method for preventing a linear velocity deviation from occurring in a steady state of a disk, a method in which a phase error is fed back to a disk motor has been proposed (for example, see W01996/027881).

However, in the disk acceleration adjusting method of the disk play back apparatus in the related art, there is a problem as follows.

In recent years, due to reduction in the thickness of disk playback apparatus for portable applications, a thin disk mechanism has come to be used. The thin disk mechanism is mounted with a thin disk motor, in which there is a wider variation of torque than in a former thick motor. Thus, any disk acceleration method in the related art can no longer deal with such a variation of torque.

In the aforementioned disk acceleration adjusting method in the related art, the disk acceleration time is set at a fixed value. Therefore, due to the variation of toque in the disk motor, acceleration and deceleration are repeated till servo lock is achieved, for example, when the number of disk revolutions when the elapsed time counted since the start of disk acceleration has reached a predetermined time deviates large from a regular number of disk revolutions. Thus, an unnecessary current is consumed in the disk motor during the repetiti on of acceleration and deceleration, so that the current consumption increases.

### SUMMARY OF THE INVENTION

The present invention was developed in consideration of such circumstances. It is an object of the invention to provide disk play back apparatus and a disk acceleration adjusting method in which a disk acceleration time can be determined properly even when there is a variation of toque in a disk motor.

The foregoing object is attained by the following configurations or methods.

A disk playback apparatus for reproducing data recorded in a disk includes a disk acceleration time setting unit for prolonging a disk acceleration time set at present time when servo lock has not been achieved by acceleration for the disk acceleration time since starting rotating the disk, and thereafter shortening the disk acceleration time when servo lock is achieved.

In the disk playback apparatus, the disk acceleration time setting unit having shortened the disk acceleration time further reads a number of disk revolutions in the servo lock, obtains a difference between the read number of disk revolutions and a regular number of disk revolutions, and finely adjusts the disk acceleration time based on a value of the difference.

In the disk playback apparatus, the disk acceleration time setting unit compares the read current number of disk revolutions with the regular number of disk revolutions, increases the disk acceleration time when the current number of disk revolutions is not larger than the regular number of disk revolutions, and reduces the disk acceleration time when the current number of disk revolutions is larger than the regular number of disk revolutions.

The disk playback apparatus according to the invention further comprises a storage unit for storing a disk acceleration time, and a data storage control unit for making the storage unit store a disk acceleration time set currently when power is cut off, and giving the disk acceleration time stored in the storage unit to the disk acceleration time setting unit when power is turned on next time.

A disk acceleration adjusting method for adjusting disk acceleration before starting reading data recorded in a disk comprises a disk acceleration time adjusting step including prolonging a disk acceleration time set at present time when servo lock has not been achieved by acceleration for the disk acceleration time since starting rotating the disk, and thereafter shortening the disk acceleration time when servo lock is achieved.

In the disk acceleration adjusting method, further after shortening the disk acceleration time, the disk acceleration time adjusting step further includes reading a number of disk revolutions in the servo lock; comparing the read current number of disk revolutions with a regular number of disk revolutions, increasing the disk acceleration time when the current number of disk revolutions is not larger than the regular number of disk revolutions, and reducing the disk acceleration time when the current number of disk revolutions is larger than the regular number of disk revolutions.

A disk acceleration adjusting program for adjusting disk acceleration before starting reading data recorded in a disk. The disk acceleration adjusting program makes a computer execute a disk acceleration time adjusting procedure including prolonging a disk acceleration time set at present time when servo lock has not been achieved by acceleration for the disk acceleration time since starting rotating the disk, and thereafter shortening the disk acceleration time when servo lock is achieved.

In the disk acceleration adjusting program, further after shortening the disk acceleration time, the disk acceleration time adjusting procedure further includes reading a number of disk revolutions in the servo lock, comparing the read current number of disk revolutions with a regular number of disk revolutions, increasing the disk acceleration time when the current number of disk revolutions is not larger than the regular number of disk revolutions, and reducing the disk acceleration time when the current number of disk revolutions is larger than the regular number of disk revolutions.

In the disk playback apparatus, the disk acceleration time is prolonged when servo lock has not been achieved since the start of disk rotation, and thereafter the disk acceleration time is shortened when servo lock is achieved. Accordingly, the disk acceleration time is set at a proper value even when there is a variation of torque in the disk motor. As a result, the operation of repeating acceleration and deceleration till servo lock is achieved can be suppressed to the minimum. Thus, unnecessary current consumption is reduced so that the power consumption can be reduced.

Incidentally, as a method for increasing the disk acceleration time, for example, the set disk acceleration time may be multiplied, or a constant time may be added to the set disk acceleration time. On the other hand, as a method for reducing the disk acceleration time, for example, the set disk acceleration time may be divided by an integer, or a constant time may be subtracted from the set disk acceleration time.

In the disk playback apparatus, further after the disk acceleration time is shortened, a number of disk revolutions in the servo lock is read, a difference between the read number of disk revolutions and a regular number of disk revolutions is obtained, and the disk acceleration time is finely adjusted based on a value of the difference. Accordingly, the disk acceleration time is set with higher accuracy. As a result, the operation of repeating acceleration and deceleration till servo lock is achieved can be suppressed to be lower. Thus, the power consumption can be made lower.

In the disk playback apparatus, the disk acceleration time set currently when power is cut off is stored, and used as a disk acceleration time when power is turned on next time. Accordingly, the disk playback apparatus can start up earlier. That is, the starting time can be shortened.

In the disk acceleration adjusting method, the disk acceleration time is prolonged when servo lock has not been achieved since the start of disk rotation, and thereafter the disk acceleration time is shortened when servo lock is achieved. Accordingly, the disk acceleration time is set at a proper value even when there is a variation of torque in the disk motor. As a result, the operation of repeating acceleration and deceleration till servo lock is achieved can be suppressed to the minimum. Thus, unnecessary current consumption is reduced so that the power consumption can be reduced.

In the disk acceleration adjusting method, further after the disk acceleration time is shortened, a number of disk revolutions in the servo lock is read, a difference between the read number of disk revolutions and a regular number of disk revolutions is obtained, and the disk acceleration time is finely adjusted based on a value of the difference. Accordingly, the disk acceleration time can be set with higher accuracy. As a result, the operation of repeating acceleration and deceleration till servo lock is achieved can be suppressed to be lower. Thus, the power consumption can be made lower.

In the disk acceleration adjusting program, the disk acceleration time is prolonged when servo lock has not been achieved since the start of disk rotation, and thereafter the disk acceleration time is shortened when servo lock is achieved. Accordingly, the disk acceleration time is set at a proper value even when there is a variation of torque in the disk motor. As a result, the operation of repeating acceleration and deceleration till servo lock is achieved can be suppressed to the minimum. Thus, unnecessary current consumption is reduced so that the power consumption can be reduced.

In the disk acceleration adjusting program, further after the disk acceleration time is shortened, a number of disk revolutions in the servo lock is read, a difference between the read number of disk revolutions and a regular number of disk revolutions is obtained, and the disk acceleration time is finely adjusted based on a value of the difference. Accordingly, the disk acceleration time can be set with higher accuracy. As a result, the operation of repeating acceleration and deceleration till servo lock is achieved can be suppressed to be lower. Thus, the power consumption can be made lower.

### BRIEF DESCRIPTION OF THE DRAWINGS

FIG. 1 is a block diagram showing the schematic configuration of disk playback apparatus according to a first embodiment of the invention;

FIG. 2 is a flow chart showing a disk acceleration adjusting process of the disk playback apparatus in FIG. 1;

FIG. 3 is a flow chart showing a disk acceleration adjusting process of disk playback apparatus according to a second embodiment of the invention;

FIG. 4 is a flow chart showing a disk acceleration adjusting process of disk playback apparatus according to a third embodiment of the invention;

FIG. 5 is a flow chart showing the disk acceleration adjusting process of the disk playback apparatus according to the third embodiment of the invention;

FIG. 6 is a flow chart showing a disk acceleration adjusting process of disk playback apparatus according to a fourth embodiment of the invention;

FIG. 7 is a flow chart showing the disk acceleration adjusting process of the disk playback apparatus according to the fourth embodiment of the invention; and

FIG. 8 is a flow chart showing a disk acceleration adjusting process of disk playback apparatus in the related art.

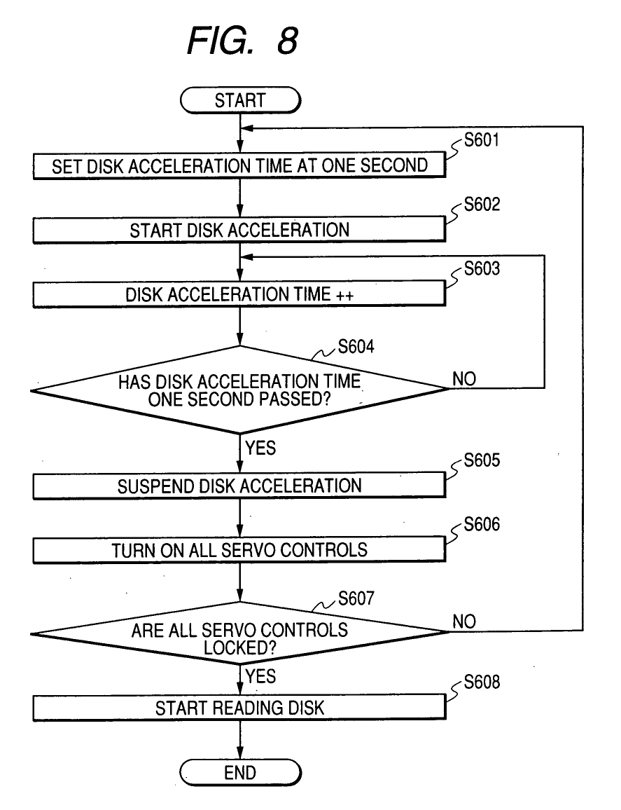

### DETAILED DESCRIPTION OF THE PREFERRED EMBODIMENTS

Preferred embodiments for carrying out the invention will be described below in detail with reference to the drawings.

### FIRST EMBODIMENT

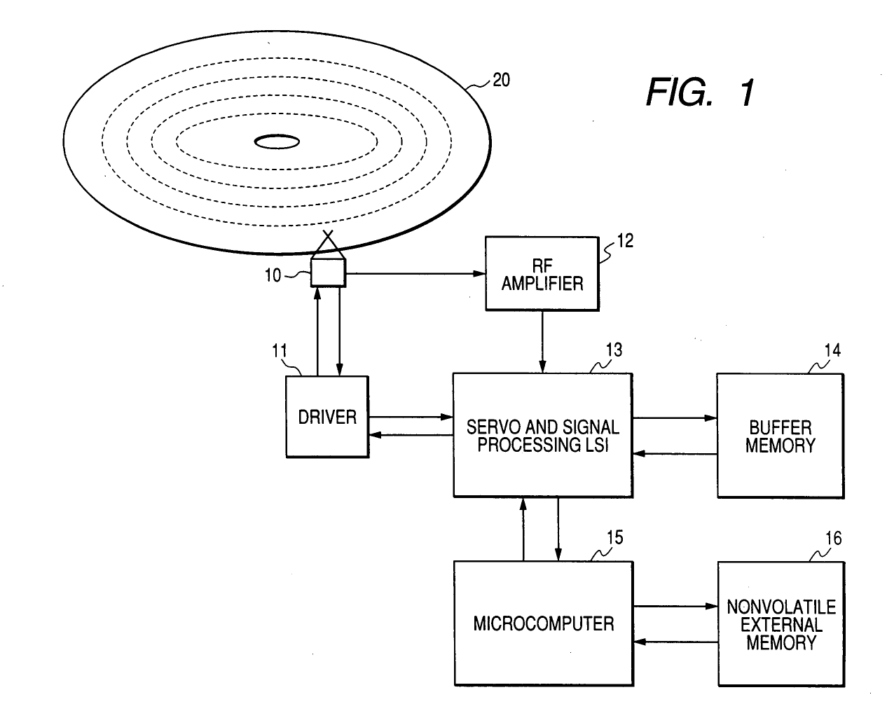

FIG. 1 is a block diagram showing the configuration of disk playback apparatus according to a first embodiment of the invention. The disk playback apparatus according to this embodiment has an optical pickup 10, a driver 11 for driving the optical pickup 10, an RF amplifier 12 for amplifying a signal from the optical pickup 10, a servo and signal processing LSI 13 for controlling the driver 11 and processing a signal from the RF amplifier 12, a buffer memory 14 to be used by the servo and signal processing LSI 13, a microcomputer 15 for controlling the servo and signal processing LSI 13, and a nonvolatile external memory 16 such as a rewritable flash memory to be used by the microcomputer 15. Incidentally, the microcomputer 15 corresponds to a disk acceleration time setting unit and a data storage control unit. In addition, the nonvolatile external memory 16 corresponds to a storage unit.

In the disk playback apparatus configured thus, first, a disk 20 is irradiated with a laser beam from the pickup 10 driven by the driver 11. The laser beam with which the disk 20 is irradiated is reflected by the disk 20, and the reflected beam is incident on the pickup 10. The optical pickup 10 converts the incident reflected beam into an electric signal, which is input to the RF amplifier 12. The RF amplifier 12 generates a focus error signal, a tracking error signal and an RF signal based on the input electric signal, and inputs these signals to the servo and signal processing LSI 13.

The servo and signal processing LSI 13 performs a focus servo process using the focus error signal input from the RF amplifier 12, so as to amplify a control signal through the driver 11 and control a not-shown focus actuator in the optical pickup 10 to thereby perform focus control. In addition, the servo and signal processing LSI 13 performs a tracking servo process using the tracking error signal input from the RF amplifier 12, so as to amplify a control signal through the driver 11 and control a not-shown tracking actuator in the optical pickup 10 to there by perform tracking control. Further, the servo and signal processing LSI 13 performs a CLV (Constant Linear Velocity) servo process using a sync signal generated by a PLL, so as to drive a not-shown disk motor through the driver 11 to thereby perform a disk servo process.

In addition, the servo and signal processing LSI 13 samples the RF signal input from the RF amplifier 12, demodulates an audio signal, and stores the audio signal into the buffer memory 14. At the same time, the servo and signal processing LSI 13 reads audio signal data stored in the buffer memory 14, converts the audio signal data into an analog sound by means of a DAC (Digital to Analog Converter), and outputs the analog sound. The audio signal to be stored in the buffer memory 14 may be once encoded by ADPCM (Adaptive Differential Pulse Code Modulation) or the like, and decoded when it is read out.

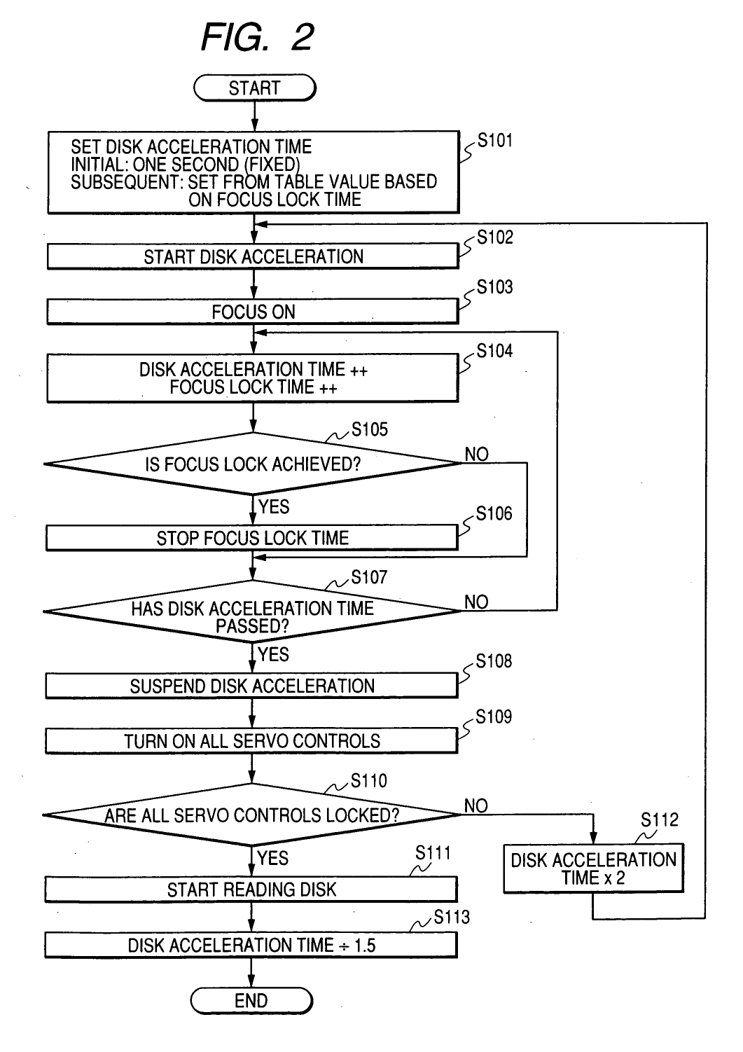

Next, a disk acceleration adjusting process to be executed by the disk playback apparatus according to this embodiment will be described with reference to the flow chart shown in FIG. 2.

After start, the disk acceleration time is set (S101) Assume that the disk acceleration time at this time is “S0”. The disk acceleration time S0 is set with reference to a table value. The disk acceleration time S0 set initially with power on is a fixed value, and the disk acceleration time S0 is set for the second or subsequent time in the following procedure. Here, assume that the initially set value of the disk acceleration time S0 is one second. Incidentally, the table value is, for example, stored in an RAM region in the microcomputer 15.

After the disk acceleration time is set, disk acceleration is started (S102), and focus control is turned on (S103). Then, an elapsed time S1 since the disk acceleration was started and an elapsed time F0 since the focus control was turned on are counted (S104). Next, it is determined whether focus lock is achieved or not (S105). When the focus lock is achieved (Yes in S105), counting the focus lock elapsed time F0 is suspended (S106). When the focus lock is not achieved (No in S105) or when counting the focus lock elapsed time F0 is suspended due to the focus lock (S106), it is determined whether the disk acceleration time has passed or not (S107).

When a measured disk acceleration time S1 exceeds the set disk acceleration time S0 in S107, the disk acceleration is suspended (S108) . When the disk acceleration time S1 does not exceed the disk acceleration time S0, the process returns to S104.

When the disk acceleration time S1 exceeds the disk acceleration time S0 and the disk acceleration is suspended, all servo controls are turned on (S109). It is determined whether all the servo controls are locked or not (S101). When all the servo controls are not locked (No in S110), the disk acceleration time S0 is multiplied by a constant value (“2” in this embodiment), and disk acceleration is performed again (S102). On the contrary, when all the servo controls are locked (Yes in S110), reading the disk 20 is started (S111) . After reading the disk 20 is started, the disk acceleration time S0 is divided by a constant value (“1.5” in this embodiment) (S113).

In the second or subsequent disk acceleration, the disk acceleration time is set by a table value (e.g. “2” or “1.5”) optimized by multiplication or division by the aforementioned constant value. This table value is stored in the RAM region in the microcomputer 15 as described above. The table value is stored correspondingly to the focus lock time on this occasion. Therefore, next time, the table value corresponding to the focus lock time is read from the RAM region in the microcomputer 15, and used for adjusting the disk acceleration time which is the initial value.

In such a manner, according to the disk playback apparatus according to this embodiment, when servo lock cannot be achieved because the number of disk revolutions cannot reach the vicinity of its regular number of disk revolutions, the table value is increased to prolong the disk acceleration time. In case of success in servo lock, the table value is reduced to shorten the disk acceleration time. Incidentally, the constant values are not limited as described above. The constant value to be multiplied can be set more than 1, and the constant value to be divided can be set more than 1 but smaller than the constant value to be multiplied.

Accordingly, it is possible to set the disk acceleration time optimized in accordance with a variation of torque in the disk motor. As a result, it is possible to save an unnecessary current which would be otherwise consumed till disk servo lock is achieved, so that it is possible to suppress the power consumption. Thus, it is possible to increase the playback time of the disk playback apparatus when it is driven by a battery.

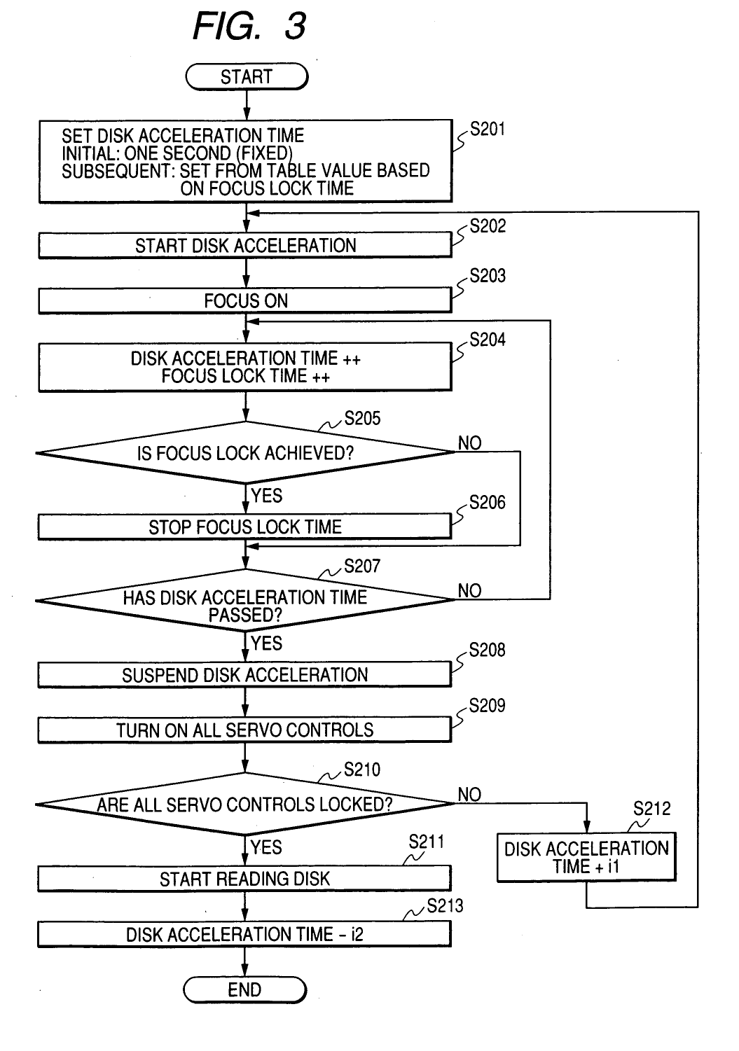

In this embodiment, the disk acceleration time is multiplied by a constant value when servo lock is not achieved, while the disk acceleration time is divided by a constant value when servo lock is achieved. However, another process may be used as shown in the flow chart of FIG. 3. That is, a constant value (i1) is added to the disk acceleration time (S212) when servo lock is not achieved (No in S210), while a constant value (i2) is subtracted from the disk acceleration time (S213) when servo lock is achieved. Incidentally, the constant value (i1) to be added (S212) can be set positive number, and the constant value (i2) to be subtracted (S213) can be set positive number but smaller than the constant value (i1) to be added.

The process shown in FIG. 3 is similar to the process shown in FIG. 2, except that they are different in the method for changing the disk acceleration time. Accordingly, description about any process other than the disk acceleration time changing process will be omitted.

### SECOND EMBODIMENT

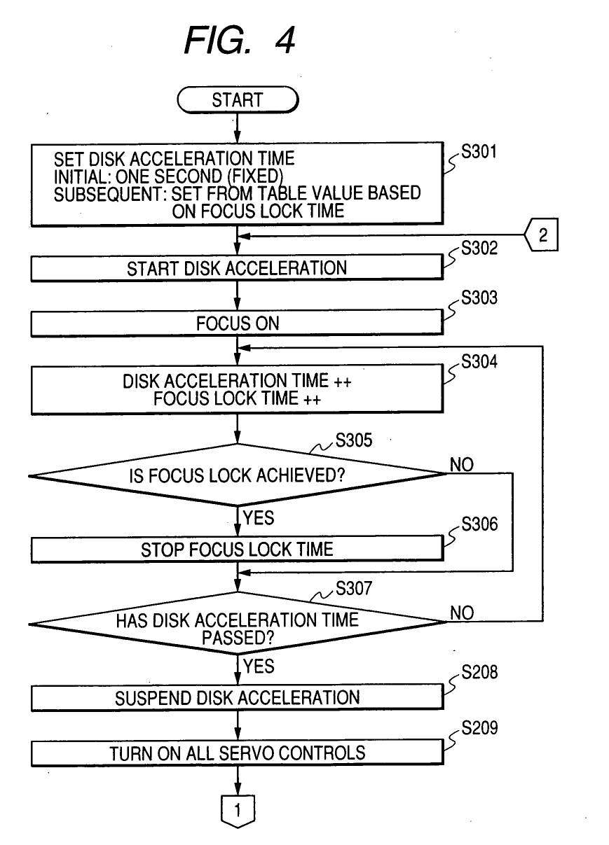

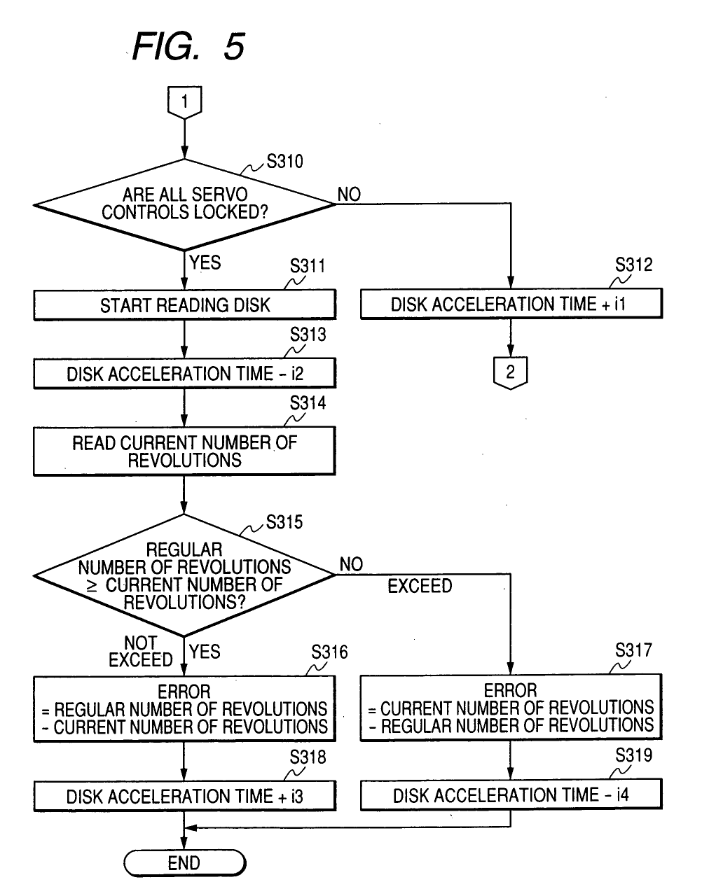

Next, a disk acceleration adjusting process of disk playback apparatus according to a second embodiment of the invention will be described with reference to the flow charts shown in FIGS. 4 and 5. Incidentally, the configuration of the disk playback apparatus according to this embodiment is similar to the disk playback apparatus according to the first embodiment described above. Therefore, the drawing of the configuration is omitted.

After start, a disk acceleration time S0 is set (S301). The disk acceleration time S0 is set with reference to a table value. The disk acceleration time S0 set initially with power on is a fixed value (one second in this embodiment), and the disk acceleration time S0 is set for the second or subsequent time in the following procedure.

After the disk acceleration time S0 is set, disk acceleration is started (S302), and focus control is turned on (S303). Then, an elapsed time S1 since the disk acceleration was started and an elapsed time F0 since the focus control was turned on are counted (S304). Next, it is determined whether focus lock is achieved or not (S305). When the focus lock is achieved (Yes in S305), counting the focus lock elapsed time F0 is suspended (S306), and it is determined whether the disk acceleration time has passed or not (S307). On the contrary, when it is concluded in S305 that the focus lock is not achieved (No in S305), the process moves directly to S307.

When a measured disk acceleration time S1 exceeds the set disk acceleration time S0 (one second) in S307, the disk acceleration is suspended (S308). When the disk acceleration time S1 does not exceed the disk acceleration time S0, the process returns to S304. After the disk acceleration is suspended in S308, all servo controls are turned on (S309). After that, it is determined whether all the servo controls are locked or not (S310). When all the servo controls are not locked (No in S310), a constant value (i1) is added to the disk acceleration time S0 (S312), and disk acceleration is performed again (S302). On the contrary, when all the servo controls are locked (Yes in S310), reading the disk is started (S311) . After reading the disk is started, a constant value (i2) is subtracted from the disk acceleration time S0 (S313).

Incidentally, the constant values (i1, i2) are not limited as described above. The constant value (i1) to be added (S312) can be set positive number, and the constant value (i2) to be subtracted (S313) can be set positive number but smaller than the constant value (i1) to be added.

After the constant value (i2) is subtracted from the disk acceleration time S0, a current number K0 of disk revolutions is read (S314). It is determined whether the current number K0 of disk revolutions exceeds a regular number K1 of disk revolutions or not (S315). When the current number K0 of disk revolutions is not larger than the regular number K1 of disk revolutions, that is, when K1>K0, the current number K0 of disk revolutions is subtracted from the regular number K1 of disk revolutions so as to obtain an error G0 (S316). Then, a table value (i3) is determined based on the error G0, and the value (i3) is added to the disk acceleration time S0 (S318). On the contrary, when it is concluded in S315 that the current number K0 of disk revolutions is larger than the regular number K1 of disk revolutions, that is, when K1<K0, the regular number K1 of disk revolutions is subtracted from the current number K0 of disk revolutions so as to obtain an error G0 (S317). Then, a table value (i4) is determined based on the error G0, and the table value (i4) is subtracted from the disk acceleration time S0 (S319).

In such a manner, according to the disk playback apparatus according to this embodiment, when servo lock cannot be achieved because the current number of disk revolutions cannot reach the vicinity of its regular number of disk revolutions, the table value is increased to prolong the disk acceleration time. In case of success in servo lock, the table value is reduced to shorten the disk acceleration time.

Accordingly, it is possible to set the disk acceleration time optimized in accordance with a variation of torque in the disk motor even when servo lock is not achieved. As a result, it is possible to save an unnecessary current which would be consumed till disk servo lock is achieved, so that it is possible to suppress the power consumption.

In spite of success in servo lock, the rotation time may exceed or not exceed a regular value set therefor. In either case, according to this embodiment, the disk acceleration time can be set more optimally by fine adjustment of the disk acceleration time.

Not to say, in this embodiment, the disk acceleration time may be multiplied by a constant value when servo lock is not achieved, and the disk acceleration time may be divided by a constant value when servo lock is achieved.

### THIRD EMBODIMENT

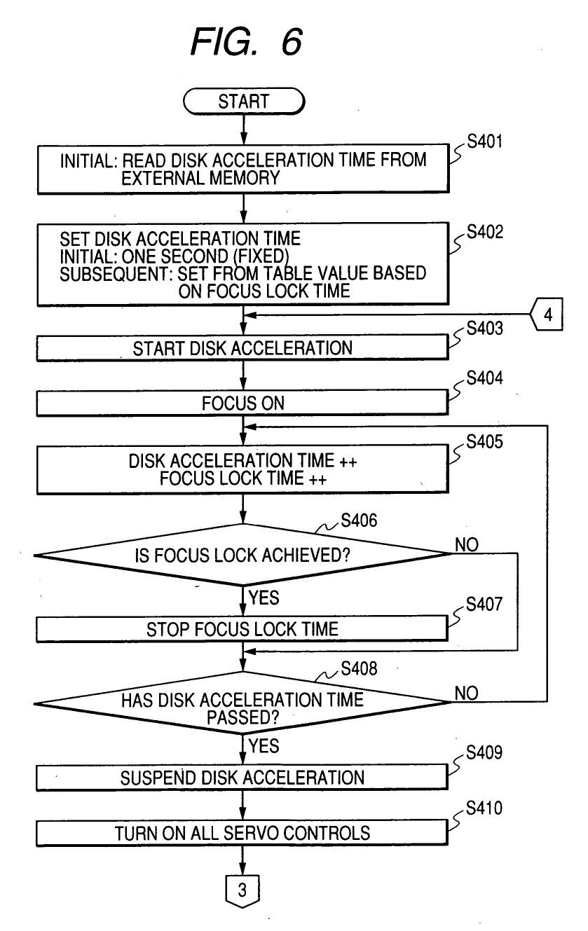

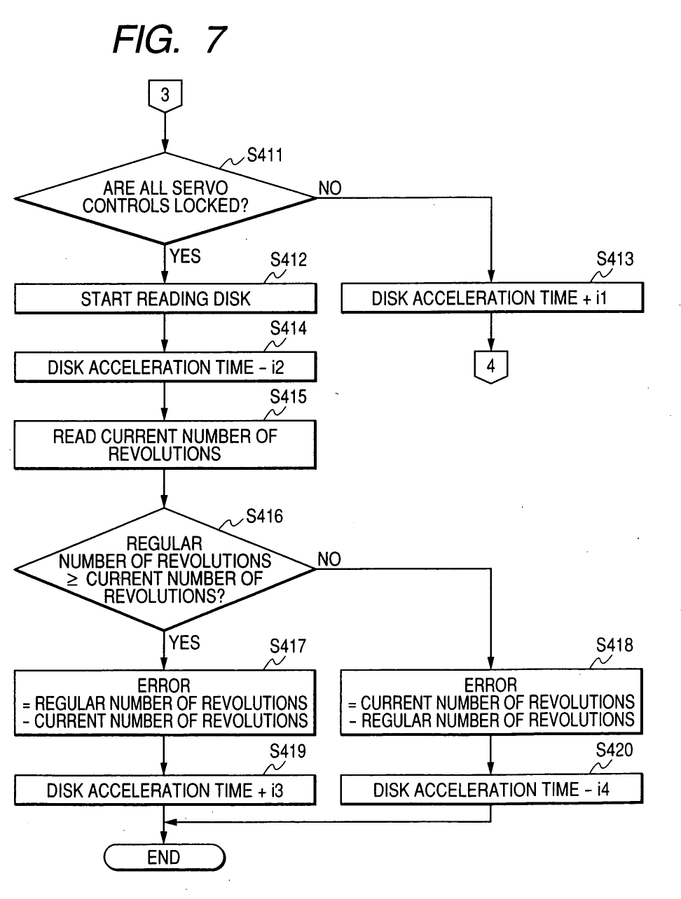

Next, a disk acceleration adjusting process of disk playback apparatus according to a third embodiment of the invention will be described with reference to the flow charts shown in FIGS. 6 and 7. Incidentally, the configuration of the disk playback apparatus according to this embodiment is similar to the disk playback apparatus according to the first embodiment described above. Therefore, the drawing of the configuration is omitted.

In the disk playback apparatus according to this embodiment, as soon as the apparatus starts up with power on, a disk acceleration time S0 is read from the nonvolatile external memory 16 (S401), and with power off, a current disk acceleration time set at that time is stored in the nonvolatile external memory 16. The other processes are similar to those in the aforementioned second embodiment, and description thereof will be omitted.

In the disk playback apparatus according to this embodiment, effect similar to that in the disk playback apparatus according to the aforementioned second embodiment can be obtained. In addition, since the disk acceleration time learned in the last operation is stored in the nonvolatile external memory 16 with power off, an optimum disk acceleration time can be set in a short time when the apparatus starts up for the second or subsequent time.

Not to say, in this embodiment, the disk acceleration time may be multiplied by a constant value when servo lock is not achieved, and the disk acceleration time may be divided by a constant value when servo lock is achieved.

In the disk playback apparatus and the disk acceleration adjusting method according to the invention, the disk acceleration time is prolonged when servo lock has not been achieved since the start of disk rotation, and thereafter the disk acceleration time is shortened when servo lock is achieved. Accordingly, the disk acceleration time is set at a proper value in spite of a variation of torque in the disk motor. As a result, the operation of repeating acceleration and deceleration till servo lock is achieved can be suppressed to the minimum. Thus, there is an effect that unnecessary current consumption is reduced so that the power consumption can be reduced. Therefore, the disk playback apparatus and the disk acceleration adjusting method according to the invention are useful as ones suitable for use in electronic equipment for reproducing data recorded in various disks, such as a CD (Compact Disk) player, a DVD (Digital Versatile Disk) player, an MO (Magneto Optical disk) drive, etc.

1. A disk playback apparatus for reproducing data recorded in a disk, comprising:
a disk acceleration time setting unit for prolonging a disk acceleration time set at present time when servo lock has not been achieved by acceleration for the disk acceleration time since starting rotating the disk, and thereafter shortening the disk acceleration time when servo lock is achieved.

2. The disk playback apparatus according to claim 1, wherein the disk acceleration time setting unit having shortened the disk acceleration time further reads a number of disk revolutions in the servo lock, obtains a difference between the read number of disk revolutions and a regular number of disk revolutions, and finely adjusts the disk acceleration time based on a value of the difference.

3. The disk playback apparatus according to claim 2, wherein the disk acceleration time setting unit compares the read current number of disk revolutions with the regular number of disk revolutions, increases the disk acceleration time when the current number of disk revolutions is not larger than the regular number of disk revolutions, and reduces the disk acceleration time when the current number of disk revolutions is larger than the regular number of disk revolutions.

4. The disk playback apparatus according to claim 1, further comprising:
a storage unit for storing a disk acceleration time; and
a data storage control unit for making the storage unit store a disk acceleration time set currently when power is cut off, and giving the disk acceleration time stored in the storage unit to the disk acceleration time setting unit when power is turned on next time.

5. The disk playback apparatus according to claim 1, wherein the data is recorded in one of various disks including optical disks and a magneto-optical disks.

6. A disk acceleration adjusting method for adjusting disk acceleration before starting reading data recorded in a disk, comprising a disk acceleration time adjusting step including:
prolonging a disk acceleration time set at present time when servo lock has not been achieved by acceleration for the disk acceleration time since starting rotating the disk; and
thereafter shortening the disk acceleration time when servo lock is achieved.

7. The disk acceleration adjusting method according to claim 6, wherein further after shortening the disk acceleration time, the disk acceleration time adjusting step further includes:
reading a number of disk revolutions in the servo lock;
comparing the read current number of disk revolutions with a regular number of disk revolutions;
increasing the disk acceleration time when the current number of disk revolutions is not larger than the regular number of disk revolutions; and
reducing the disk acceleration time when the current number of disk revolutions is larger than the regular number of disk revolutions.

8. The disk acceleration adjusting method according to claim 6, wherein the data is recorded in one of various disks including optical disks and a magneto-optical disks.

9. A disk acceleration adjusting program for adjusting disk acceleration before starting reading data recorded in a disk, the disk acceleration adjusting program making a computer execute a disk acceleration time adjusting procedure comprising:
prolonging a disk acceleration time set at present time when servo lock has not been achieved by acceleration for the disk acceleration time since starting rotating the disk; and
thereafter shortening the disk acceleration time when servo lock is achieved.

10. The disk acceleration adjusting program according to claim 9, wherein further after shortening the disk acceleration time, the disk acceleration time adjusting procedure further comprises:
reading a number of disk revolutions in the servo lock;
comparing the read current number of disk revolutions with a regular number of disk revolutions;
increasing the disk acceleration time when the current number of disk revolutions is not larger than the regular number of disk revolutions; and
reducing the disk acceleration time when the current number of disk revolutions is larger than the regular number of disk revolutions.

11. The disk acceleration adjusting program according to claim 9, wherein the data is recorded in one of various disks including optical disks and a magneto-optical disks.
